(19) United States
(12) Patent Application Publication
(10) Pub. No.: US 2007/0054137 A1
(43) Pub. Date: Mar. 8, 2007

(54) Textile coating

(75) Inventor: Johann Mueller, Konzell (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/515,980

(22) Filed: Sep. 5, 2006

(30) Foreign Application Priority Data
Sep. 8, 2005 (DE) 10 2005 042 755.3

(51) Int. Cl. B32B 9/04; C08L 83/04

(52) U.S. Cl. 428/447; 525/477; 525/478; 528/15; 528/31; 528/32

(57) ABSTRACT

A composition of: A) organopolysiloxanes having hydrocarbyl radicals having aliphatic carbon-carbon multiple bonds; B) if appropriate inhibitors; C) platinum catalyst; D) if appropriate, adhesion promoter; E) condensation catalysts; F) polysiloxanes having at least two condensation-capable groups; and G) dimethylpolysiloxanes having at least 3 SiH functions, can be employed, particularly as a textile coating, to produce coated textile products more efficiently and/or with superior properties.

### BACKGROUND OF THE INVENTION

1. Field of the Invention

This invention concerns a curable organopolysiloxane composition, a method for coating a substrate employing the composition, and a shaped body coated with the composition, in particular a coated textile fabric.

2. Background Art

EP 0 915 937 B1 describes silicone coating compositions for textile substrates that contain silicone resin and crosslink through addition of SiH onto Si-vinyl. The disadvantages of such compositions are that the crosslinking process can only be accelerated thermally and thus complete vulcanization has to be accomplished by supplying heat. This limits the coating process, and thus the overall process for producing a shaped article or a coated fabric, in terms of speed.

### SUMMARY OF THE INVENTION

It is an object of the present invention to improve upon the prior art, more particularly to provide a composition which crosslinks rapidly, if necessary with supplementary crosslinking at room temperature, and is stable in storage. These and other objects are achieved by the present invention, wherein a curable coating composition containing organopolysiloxanes bearing ethylenically unsaturated groups, platinum catalyst, SiH-functional crosslinker, condensable polysiloxane, and condensation catalyst, is employed.

### DETAILED DESCRIPTION OF THE PREFERRED EMBODIMENT(S)

The present invention thus provides a composition comprising:
A) organopolysiloxanes having hydrocarbyl radicals having aliphatic carbon-carbon multiple bonds, preferably vinyl-terminated dimethylpolysiloxanes;
B) optionally, inhibitors which inhibit the platinum-catalyzed addition reaction of SiH onto aliphatic carbon-carbon multiple bonds;
C) platinum catalyst;
D) optionally, adhesion promoter(s);
E) condensation catalysts;
F) polysiloxanes having at least two condensation-capable groups; and
G) polysiloxanes having at least 3 Si-bonded hydrogen atoms.

The organopolysiloxanes (A) are preferably linear or branched organopolysiloxanes composed of units of the general formula I

$${R}_{a}^{1} {R}_{b}^{2} {SiO}_{\frac{4 - a - b}{2}} \qquad ( I )$$

where
R¹ represents monovalent C₁ to C₁₀ hydrocarbyl radicals which are optionally substituted with halogen atoms and are free of aliphatic carbon-carbon multiple bonds,
R² represents hydrogen atoms, hydroxyl groups or monovalent hydrocarbyl radicals having aliphatic carbon-carbon multiple bonding and 2 to 8 carbon atoms per radical,
a represents the values 0, 1, 2 or 3, and
b represents the values 0, 1 or 2,
   with the proviso that there are on average at least 2 R² radicals present per molecule.

Examples of unsubstituted hydrocarbyl radicals R¹ are C₁ to C₁₀ alkyl- , C₆ to C₁₀ alkaryl- or C₆ to C₁₀ aralkyl radicals whose alkyl moiety is saturated, or C₆ to C₁₀ aryl radicals. Examples of alkyl radicals R¹ are methyl, ethyl, n-propyl, isopropyl, n-butyl, isobutyl, tert-butyl, n-pentyl, isopentyl, neopentyl, and tert-pentyl radicals; hexyl radicals such as n-hexyl and cyclohexyl radicals; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; and cycloalkyl radicals, such as the cyclohexyl radical. Examples of alkaryl radicals R¹ are the α-phenylethyl and β-phenylethyl radicals; examples of aralkyl radicals R¹ are the benzyl and 2,4-diethylbenzyl radicals; examples of aryl radicals R¹ are the phenyl and naphthyl radicals. Preferably, R¹ represents C₁ to C₆ alkyl radicals and phenyl radicals, in particular methyl and ethyl radicals.

Examples of halogen-substituted hydrocarbyl radicals R are the 3,3,3-trifluoro-n-propyl, 2,2,2,2′,2′,2′-hexafluoroisopropyl, heptafluoroisopropyl, 3-chloro-n-propyl, the 2-ethyl bromide and 3-propyl bromide radicals. Preferably, the R¹ radicals are not substituted.

Examples of monovalent hydrocarbyl radicals having aliphatic carbon-carbon multiple bonding and 2 to 8 carbon atoms per R² radical are alkenyl radicals such as vinyl, 5-hexenyl, 1-propenyl, allyl, 1-butenyl and 1-pentenyl; and alkynyl radicals, such as ethynyl, propargyl and 1-propynyl.

Preferably, the organopolysiloxanes (A) comprise at least 90 and especially at least 95 mol % of units of the general formula I in each of which the sum a+b is =2.

Preferably, the organopolysiloxanes (A) comprise at least 60, in particular at least 80 and specifically at least 95 mol % of units of the general formula I, in each of which b has the value 0.

Those organopolysiloxanes (A) which possess hydrocarbyl radicals having aliphatic carbon-carbon multiple bonds preferably have on average 2 to 10 and in particular 2 to 4 aliphatic carbon-carbon multiple bonds per molecule. Preferably, the terminal units of the general formula I have aliphatic carbon-carbon multiple bonds. Preferably, the aliphatic carbon-carbon multiple bonds are double bonds, preference being given to vinyl-terminated polysiloxanes and particular preference to vinyl-terminated dimethylpolysiloxanes. The organopolysiloxanes (A) may have a molecular weight in the range from 186 to 1,000,000 g/mol. The range from 260 to 500,000 g/mol is preferred. The formulation can be based on a polymer of narrow molecular weight distribution, but it is also possible to use polymers having different molecular weights. Polymers having vinyl functions in the chain can be used in the formulation.

The organopolysiloxane (A) which is used according to the present invention and comprises condensation-capable groups can be a single variety of such organopolysiloxanes comprising condensation-capable groups but also a mixture of at least two varieties of such organopolysiloxanes comprising condensation-capable groups.

The organopolysiloxanes (G) having at least 3 Si-bonded hydrogen atoms preferably have on average 2 to 50 and in particular 5 to 20 Si-bonded hydrogen atoms per molecule. The organopolysiloxanes (1b) preferably have an average viscosity of at least 10 mPa·s and in particular at least 30 mPa·s and preferably not more than 10⁶ mPa·s and in particular not more than 10,000 mPa·s, all at 25° C.

Those organopolysiloxanes (A) which have Si-bonded hydroxyl groups preferably possess 2 to 4 hydroxyl groups per molecule. They preferably possess terminal hydroxyl groups. The organopolysiloxanes (A) preferably have an average viscosity of at least 10 mPa·s and in particular at least 1000 mPa·s and preferably not more than 10⁸ mPa·s and in particular not more than 5×10⁶ mPa·s at 25° C.

Preferred fillers are reinforcing fillers such as pyrogenic silica and precipitated silica. Particular preference is given to reinforcing fillers produced by a prehydrophobicization (similarly to the EP0378785B1 patent), for example with organosilanes, and having a preferred BET surface area of at least 50 m²/g, in particular at least 100 m²/g and more preferably of at least 150 m²/g. The amount of filler can comprise 10% to 60% by weight of the total mixture, in which case the range from 15% to 45% by weight is preferred and the range from 20% to 40% by weight is particularly preferred.

Inhibitors (B) are known per se. Examples thereof are acetylenically unsaturated alcohols, such as 3-methyl-1-butyn-3-ol, 1-ethynylcyclohexan-1-ol, 3,5-dimethyl-1-hexyn-3-ol and 3-methyl-1-pentyn-3-ol. Examples of vinylsiloxane-based inhibitors are 1,1,3,3-tetramethyl-1,3-divinylsiloxane and vinyl-containing oligo-and disiloxanes.

The platinum catalysts (C) used are preferably platinum metals and/or their compounds, preferably platinum and/or its compounds. Examples of such catalysts are metallic and finely divided platinum which may be situated on supports, such as silica, alumina or activated carbon, compounds or complexes of platinum, such as platinum halides, for example PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, in particular platinum-divinyltetramethyldisiloxane complexes with or without detectable inorganically bound halogen, bis(gammapicoline)platinum dichloride and also reaction products of platinum tetrachloride with olefin and with primary amine or secondary amine or primary amine and secondary amine, such as the reaction product of platinum tetrachloride, dissolved in 1-octene, with sec-butylamine, or ammonium-platinum complexes, platinum catalysts for 1K systems, such as microencapsulated platinum complexes or, for example, platinum-acetylide complexes. The transition metal catalyst is preferably used in amounts from 0.5 to 500 weight ppm (weight fractions per million weight fractions), in particular 2 to 400 weight ppm, all calculated as elemental transition metal and based on the total weight of the organosiloxane components.

D) The formulation may include silane adhesion promoters. Examples thereof are: vinyltrialkoxysilanes, methacryloyloxypropyltrialkoxysilanes, epoxypropyltrialkoxysilanes, silanes having acetoxy groups, and mixtures thereof and their hydrolyzates, or to be more precise, mixed hydrolyzates.

E) The formulation may include catalysts to speed the condensation reaction. Examples thereof are metal chelates such as aluminum acetylacetonate, calcium acetylacetonate or else organic salts of metals such as zirconium or titanium. Examples thereof are zirconium butoxide, zirconium isopropoxide, titanium tetrabutoxide, titanium isopropoxide and also (organo)metal compounds, for example salts of carboxylic acids, the alkoxides and the halides of the metals Zn, Zr, Ti, Fe, Ba, Ca and Mn. Particular preference is given to (organo)zirconium compounds of carboxylic acids having 1 to 18 carbon atoms. The formulation may also include mixtures of these compounds.

F) Polysiloxanes having at least 2 condensable groups, preferably Si—OH or 2 Si—OR functions. These polysiloxanes may also include T and/or Q functions; that is, they may be defined as silicone resins.

A) Vinyl polymers are the main constituent of the formulation of the present invention and will hereinafter always be assumed at 100 parts by weight. This shall be the reference standard.

B) Based on 100 parts by weight of component A, the inhibitor is used in an amount of 0.01 to 3 parts by weight. Preferred amounts are 0.02 to 1 part by weight. Particular preference is given to 0.03 to 0.5 part by weight.

C) Platinum catalysts are used in amounts to obtain a total platinum content in the ready-produced formulation of 0.01 to 1000 ppm. Preference is given to 0.05 to 500 ppm and particular preference given to 0.1 to 100 ppm

D) Adhesion promoters can be included in amounts from 0.01 to 20 parts by weight. Preference is given to 0.05 to 10 parts by weight and particular preference given to 0.1 to 5 parts by weight.

E) Condensation catalysts can be included in amounts from 0.01 to 20 parts by weight. Preference is given to 0.05 to 10 parts by weight, with particular preference, to 0.1 to 5 parts by weight.

F) Polysiloxanes having Si—OH and/or Si—OR functions are present in amounts of 0.1 to 70 parts. Preference is given to 0.5 to 50 parts by weight and particular preference is given to 1 to 40 parts by weight.

G) Crosslinkers can be included in amounts from 0.05 to 20 parts by weight. Preference is given to 0.1 to 10 parts by weight, with particular preference to 0.5 to 5 parts by weight.

The coating compositions of the present invention are produced by simply mixing the components A to F together in the amounts already described.

The mixing process can be effected using simple stirring equipment, for example vane stirrers, planetary mixers, turbostirrers or dissolvers. The stirred vessel can be open or closed. The mixing operation is preferably carried out at ambient temperature, but temperatures ranging from −40° C. to +150° C. are also possible.

It is also possible for reactions such as addition polymerization, condensations, or conversion of reactive groups to be carried out during or following mixing, requiring thermal control of the reaction sequences. Such processes are conducted between 0° C. and 150° C., preferably at temperatures between 10° C. and 120° C. For simplicity, the compositions are produced at standard atmospheric pressure. But the production can take place at a superatmospheric pressure of up to 20 bar or under a reduced pressure down to 20 mbar and also under protective gas.

The mixing process can be carried out batchwise or else continuously in suitable equipment. Examples of such equipment are Buss kneaders, and static or dynamic in-line mixers.

Possible fields of use for the novel preparation are: coatings of textile fabrics such as for example wovens, nonwovens, drawn-loop knits, laid scrims, felts, formed-loop knits or warp knits. The textile fabrics may be fabricated from natural fibers, such as cotton, wool, silk, etc or else from manufactured fibers such as polyester, polyamide, aramid, etc. The textiles may also be fabricated from mineral fibers such as glass or silicates or metal fibers.

The textile fabrics coated with the compositions of the present invention can be used for industrial applications such as for example conveyor belts, bellow expansion joints, protective clothing, awnings, insulation or air bags.

But the compositions of the present invention are also useful in the high performance textile sector, such as paragliders, hot air balloons, parachutes, outdoor apparel, sports textiles, leisure apparel, leisure articles such as tents or backpacks, sails and streetwear.

The products described may also be used for coating free-standing films or surfaces composed of mineral materials, plastics, natural materials or metals. The compositions described can further be used for producing shaped articles. Furthermore, there are many substrates, for example paper, mineral building materials, plastics, wood and many other underlays which can be treated with the formulations of the present invention.

The formulations of the present invention which are produced in this way are applied to textile materials using methods common in the textile dyeing and finishing industry, such as padding, dipping with or without subsequent mangle, doctoring or coating by roll application, screenprinting, brushing or engraved rolls or, extrusion processes, squirting or spraying processes, or in any desired manner. Similarly, all varieties of roller coatings, such as gravure rolls, padding or application via multiroll systems are possible. The compositions described are also useful for laminating and for processing in the transfer process. Shaped articles can be produced by injection molding or casting.

Drying and vulcanization is effected in customary thermal ducts, which can be heated by means of hot air or infrared radiation or other sources of energy. The preferred temperature range is 50-200° C. Since some varieties of textile are not particularly thermally stable, the upper temperature limit is usually dictated by the thermal stability of the textile. The residence time in the drying oven is dependent on the temperature in the thermal duct and is preferably in the range from 0.5 to 30 minutes.

Wovens composed of glass fibers fray very badly at cuts; the treatment prevents fraying of the cut edges. Glass dust due to the fracture of fine glass fibers is fixed by finishing with formulations of the present invention. A woven glass fabric finished in this way further exhibits elastic properties.

### EXAMPLES

### Example 1

### Comparative

100 kg of dimethylpolysiloxane having a viscosity of 100,000 mPa·s and vinyl end groups are mixed with 42 kg of dimethylpolysiloxane having a viscosity of 1000 mPa·s and vinyl end groups using a vane stirrer.

0.1 kg of ethynylcyclohexanol and 0.5 kg of a platinum-divinyltetramethylsiloxane complex, dissolved in dimethylpolysiloxane so that a platinum content of 1% by weight is present, are added with continuous mixing. The mixture is further stirred for 30 minutes until mixing is complete.

100 g of the composition thus obtained are mixed with 2 g of a methylhydropolysiloxane having trimethyl end groups and a viscosity of 60 mPa·s.

This mixture is doctor coated onto a woven nylon-6,6 fabric and vulcanized at 180° C. for 2 minutes.

The woven fabric thus coated has a coating weight of 24 g/m² and exhibits the following measurements:

Hydrohead: >1000 mm

Scrub: 400 (ISO 5981)

Adhesion: 110 N/5 cm (ISO 53530)

### Example 2

100 kg of dimethylpolysiloxane having a viscosity of 100,000 mPa·s and vinyl end groups are mixed with 42 kg of dimethylpolysiloxane having a viscosity of 1000 mPa·s and vinyl end groups using a vane stirrer.

0.1 kg of ethynylcyclohexanol and 0.5 kg of a platinum-divinyltetramethylsiloxane complex, dissolved in dimethylpolysiloxane so that a platinum content of 1% by weight is present, 3 kg of epoxypropyltriethoxysilane and 0.3 kg of zirconium butoxide and 20 kg of a polysiloxane comprising M, D, T and Q units and also 0.2% of Si—OH and 0.1% of SiOEt are added with continuous mixing. The mixture is further stirred for 30 minutes until mixing is complete.

100 g of the composition thus obtained are mixed with 2 g of a methylhydropolysiloxane having trimethyl end groups and a viscosity of 60 mPa·s.

This mixture is doctor coated onto a woven nylon-6,6 fabric and vulcanized at 180° C. for 2 minutes.

The woven fabric thus coated has a coating weight of 22 g/m² and exhibits the following measurements:

Hydrohead: >1000 mm

Scrub: >2000 (ISO 5981)

Adhesion: 240 N/5 cm (ISO 53530)

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A curable organopolysiloxane composition comprising:
A) organopolysiloxane(s) bearing hydrocarbyl radicals having aliphatic carbon-carbon multiple bonds;
B) optionally inhibitors of platinum catalyzed hydrosilylation;
C) platinum catalyst(s);
D) optionally, adhesion promoter(s);
E) at least one condensation catalyst;
F) at least one polysiloxane having at least two condensation-capable groups; and
G) dimethylpolysiloxanes having at least 3 SiH functions.

2. The composition of claim 1 wherein organopolysiloxanes having hydrocarbyl radicals having aliphatic carbon-carbon multiple bonds are vinyl-terminated dimethylpolysiloxanes.

3. The composition of claim 1, wherein the condensation-capable groups are selected from Si—OH groups and silicon-bonded alkoxy groups.

4. A method of coating textile fabrics, comprising applying a composition of claim 1 to a textile substrate, and curing the composition.

5. A textile shaped body coated with a cured composition of claim 1.

6. A textile shaped body coated with a cured composition of claim 2.

7. A textile shaped body prepared by the method of claim 4.
